(19) United States
(12) Patent Application Publication
(10) Pub. No.: US 2015/0017534 A1
(43) Pub. Date: Jan. 15, 2015

(54) RESIN COMPOSITION FOR LITHIUM ION CELL POSITIVE ELECTRODE

(71) Applicants: NATIONAL INSTITUTE OF ADVANCED INDUSTRIAL SCIENCE AND TECHNOLOGY, Tokyo (JP); TORAY INDUSTRIES, INC., Tokyo (JP)

(72) Inventors: Takuhiro Miyuki, Ikeda-shi (JP); Yasue Okuyama, Ikeda-shi (JP); Tetsuo Sakai, Ikeda-shi (JP); Tomoyuki Yuba, Otsu-shi (JP); Natsuko Chayama, Otsu-shi (JP); Masao Tomikawa, Otsu-shi (JP)

(21) Appl. No.: 14/375,650

(22) PCT Filed: Jan. 30, 2013
(86) PCT No.: PCT/JP2013/051988

§ 371 Date: Jul. 30, 2014

(30) Foreign Application Priority Data
Jan. 31, 2012 (JP) 2012-018283

(51) Int. Cl. H01M 4/62; H01M 4/485; H01M 10/0525; H01M 4/36

(52) U.S. Cl. CPC H01M 4/622; H01M 4/366; H01M 4/485; H01M 10/0525; H01M 4/623; H01M 2220/20
USPC 429/217

(57) ABSTRACT

Disclosed is a resin composition for positive electrodes of lithium ion cells, which imparts strong adhesiveness and electrolyte injectability and shows good discharge and charge characteristics and input-output characteristics with smaller amount of a binder. The resin composition for positive electrodes of lithium ion cells is a resin composition for positive electrodes of lithium ion cells, which comprises a polyimide precursor whose average thermal linear expansion coefficient in the range of 20° C. to 200° C. after being imidized is 3 to 50 ppm, and/or a polyimide whose average thermal linear expansion coefficient in the range of 20° C. to 200° C. is 3 to 50 ppm, and a positive electrode active compound, wherein the positive electrode active compound is one obtained by coating the surface of a composite oxide containing lithium with a lithium ion conductive material.

### TECHNICAL FIELD

The present invention relates to a resin composition for positive electrodes of lithium ion cells.

### BACKGROUND ART

In recent years, due to the progress in electronic technology, performance improvement, miniaturization and portable use of electronic devices have proceeded, and with the drastic diffusion of notebook personal computers and cellular phones, the demand for secondary batteries which are rechargeable, compact, light-weight, and which has high capacity, high energy density and high reliability is increasing. Further, in automobile industry, expectations for reducing emissions of carbon dioxide by introducing electric vehicles (EV) and hybrid electric vehicles (HEV) have been raised, and secondary batteries for driving motors, which are the key to the practical application thereof, have been intensively developed.

In particular, lithium ion secondary batteries which are said to have the highest theoretical energies among batteries are drawing attention and are now being rapidly developed. In general, the lithium ion secondary battery has a constitution wherein a positive electrode obtained by coating a collector such as aluminum with a positive electrode active compound such as a composite oxide containing lithium by using a binder, and a negative electrode obtained by coating a collector such as copper with a negative electrode active compound capable of adsorbing and desorbing lithium ions by using a binder, are connected through a separator and electrolyte layer and the resultant is hermetically covered.

Fluororesins such as polyvinylidene fluoride (hereinafter referred to as PVdF) and polytetrafluoroethylene (hereinafter referred to as PTFE) are suitably used as a binder for positive electrodes owing to the excellent anti-oxidation property. However, these resins have low adhesiveness to active compounds and/or collectors, and the repeated discharge and charge cause detachment of active compounds form a collector or mutual separation of active compounds, thereby reducing the cell capacity. As a result, it has been pointed out that the cell performance sufficient for EV and HEV applications in which severe vibratory loadings are applied may not be maintained. Also, when the amount of a binder is increased to improve adhesiveness, problems have arisen in that the electrode resistance is increased, or the electrolyte infusion rate is decreased, thereby deteriorating input-output characteristics.

In recent years, it has been reported that a polyimide resin is used as a binder for positive electrodes to improve adhesiveness (Patent Documents 1 to 5), and that the improvement of cycle characteristics can be attained by using a solvent-soluble polyimide (Patent Document 6).

However, in the above-described reports, polymers having imido ring structures are likely to agglutinate during drying the coated electrode, and thus there were problems in that the electrode has rigid property and cracking or the like caused by deformation of the electrode is likely to occur, thereby reducing discharged capacity. Also, a polyamic acid which is one of polyimide precursors was said to be inappropriate since water generated during imidization adversely affects a positive electrode active compound. Further, there were concerns that the agglutination of the polyimides reported therein causes the increase in the electrode resistance and the decrease in electrolyte infusion rate, thereby deteriorating input-output characteristics.

### PRIOR ART DOCUMENTS

### Patent Documents

Patent Document 1: JP 2007-48525 A
Patent Document 2: JP 2007-109631 A
Patent Document 3: JP 2007-280687 A
Patent Document 4: JP 2008-21614 A
Patent Document 5: JP 2011-86480 A
Patent Document 6: JP 10-188992 A

### SUMMARY OF THE INVENTION

### Problems to be Solved by the Invention

An object of the present invention is to provide a resin composition for positive electrodes of lithium ion cells, which imparts strong adhesiveness and electrolyte injectability and shows good discharge and charge characteristics and input-output characteristics with smaller amount of a binder.

### Means for Solving the Problems

The present inventors intensively studied to discover that strong adhesiveness and electrolyte injectability can be imparted and good discharge and charge characteristics and input-output characteristics can be achieved with smaller amount of a binder by using as a resin for positive electrodes of lithium ion cells, a resin composition comprising a polyimide precursor or polyimide having a specified average thermal linear expansion coefficient, or a polyimide precursor having a specified structure, and as a positive electrode active compound, one obtained by coating the surface of a composite oxide containing lithium with a lithium ion conductive material, thereby completing the present invention.

That is, the present invention provides a resin composition for positive electrodes of lithium ion cells, the composition comprising a polyimide precursor whose average thermal linear expansion coefficient in the range of 20° C. to 200° C. after being imidized is 3 to 50 ppm, and/or a polyimide whose average thermal linear expansion coefficient in the range of 20° C. to 200° C. is 3 to 50 ppm, and a positive electrode active compound, wherein the positive electrode active compound is one obtained by coating the surface of a composite oxide containing lithium with a lithium ion conductive material.

The present invention also provides a resin composition for positive electrodes of lithium ion cells, the composition comprising a polyimide precursor having a repeating structure represented by Formula (1) below and a positive electrode active compound, wherein the positive electrode active compound is one obtained by coating the surface of a composite oxide containing lithium with a lithium ion conductive material:

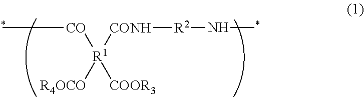

(wherein R¹ is a tetravalent organic group having 4 or more carbon atoms; R² is a divalent organic group having 4 or more carbon atoms; R³ and R⁴ are optionally the same or different, and each of R³ and R⁴ is hydrogen or an organic group having 1 to 10 carbon atoms).

The present invention further provides a resin composition for positive electrodes of lithium ion cells, the composition comprising a polyimide having a repeating structure represented by Formula (6) below and a positive electrode active compound, wherein the positive electrode active compound is one obtained by coating the surface of a composite oxide containing lithium with a lithium ion conductive material; and 50 to 100% of R¹² in the structure of the polyimide having a repeating structure represented by the Formula (6) are represented by one or more structures selected from Formulae (7) to (9):

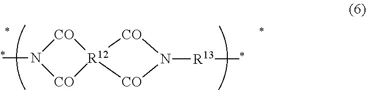

(wherein R¹² is a tetravalent organic group having 4 or more carbon atoms; and R¹³ is a divalent organic group having 4 or more carbon atoms);

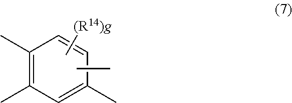

(wherein R¹⁴s are optionally the same or different, and each R¹⁴ is an organic group having 1 to 10 carbon atoms, nitro group, Cl, Br, I or F; and g is an integer of 0 to 2);

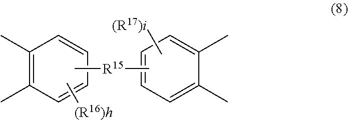

(wherein R¹⁵ is an organic group selected from the group consisting of a single bond, —O—, —S—, —CO—, —C(CF₃)₂— and —CONH—; each of R¹⁶ and R¹⁷ is an organic group having 1 to 10 carbon atoms, nitro group, hydroxyl group, sulfonic group, Cl, Br, I or F wherein the same groups are optionally employed or different groups are optionally employed in combination as each of R¹⁶s and R¹⁷s; and h and i are integers of 0 to 3);

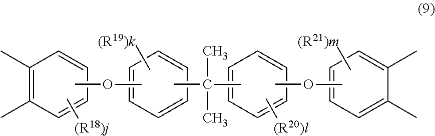

(wherein each of R¹⁸ to R²¹ is an organic group having 1 to 10 carbon atoms, nitro group, Cl, Br, I or F wherein the same groups are optionally employed or different groups are optionally employed in combination as each of R¹⁸s to R²¹s; j and m are integers of 0 to 3; and k and 1 are integers of 0 to 4).

The present invention further provides a positive electrode for lithium ion cells, the electrode comprising a metal foil and the composition according to the above-described present invention, which composition was applied on one side or both sides of the metal foil.

### Effect of the Invention

By the present invention, a resin composition for positive electrodes of lithium ion cells, which imparts strong adhesiveness and electrolyte injectability and shows good discharge and charge characteristics and input-output characteristics with smaller amount of a binder, can be provided.

### MODE FOR CARRYING OUT THE INVENTION

The resin composition for positive electrodes of lithium ion cells, according to the present invention, comprises a polyimide precursor whose average thermal linear expansion coefficient in the range of 20° C. to 200° C. after being imidized is 3 to 50 ppm and/or a polyimide whose average thermal linear expansion coefficient in the range of 20° C. to 200° C. is 3 to 50 ppm.

The polyimide precursor and/or polyimide is(are) mixed with a positive electrode active compound, the obtained mixture is applied on a collector, and the collector is subjected to a heat treatment to function as a positive electrode. In cases where the polyimide precursor is used, an imidization reaction is allowed to proceed during the heat treatment to obtain a polyimide.

The polyimide whose average thermal linear expansion coefficient in the range of room temperature to 200° C. is 3 to 50 ppm can suppress cracking or the like caused by deformation of the electrode. In cases where the polyimide precursor is used, agglutination of polymers can be prevented during heat treatment accompanying imidization to obtain a more flexible electrode after imidization, and the obtained electrode becomes resistant to cracking or the like caused by the deformation. The average thermal linear expansion coefficient is preferably 5 to 30 ppm, and more preferably 10 to 20 ppm.

In cases where the average thermal linear expansion coefficient in the range of room temperature to 200° C. is less than 3 ppm, there are problems in that the electrode has a rigid property, and cracking or the like is likely to be generated by deformation of the electrode, thereby reducing the discharged capacity. In cases where the average thermal linear expansion coefficient in the range of room temperature to 200° C. is higher than 50 ppm, the difference of the expansion coefficients between the polyimide and the collector is too large, and the residual stress of the positive electrode is increased, which also results in cracking or the like caused by deformation of the electrode.

In the resin composition for positive electrodes of lithium ion cells, according to the present invention, the positive electrode active compound obtained by coating a composite oxide containing lithium with a lithium ion conductive material is used.

Examples of the composite oxide containing lithium include lithium cobaltate (LiCoO₂), lithium iron phosphate (LiFePO₄), lithium nickelate (LiNiO₂), LiMn₂O₄, LiNi_{0.33}Mn_{0.33}CO_{0.33}O₂, LiNi_{0.8}Co_{0.15}Al_{0.05}O₂, but the composite oxide is not restricted thereto.

By employing the positive electrode active compound whose surface was coated, the chemical reaction between the polyimide precursor and/or polyimide and the positive electrode active compound can be suppressed, and discharge and charge characteristics and input-output characteristics are dramatically improved.

In particular, a lithium ion conductive material having a water-resistant property is preferable. The coating with the water-resistant material has an advantage that water generated during the imidization of the polyimide precursor is blocked from contacting directly with the positive electrode active compound, and hydrolysis of the positive electrode active compound or generation of LiOH, HF and the like by reaction between impurities in the positive electrode active compound and water can be suppressed.

Further, a lithium ion conductive material having an oxidation-reduction potential of not more than 2.5 V vs Li+/Li is preferable. The coating with the material having an oxidation-reduction potential of not more than 2.5 V vs Li+/Li has an advantage that an oxidative decomposition of the polyimide precursor and/or polyimide can be prevented by a redox species in the positive electrode active compound.

Preferred examples satisfying the above-mentioned requirements include one or more compounds selected from the group consisting of C (carbon), Li₄Ti₅O₁₂, Li₂CrO₄, Li₂ZrO₃, LiNbO₃, Al, Al₂O₃, ZnO, Bi₂O₃, AlPO₄, Li₂SiO₃, Li₄SiO₄, the other Li—Si—Oₓ, SiOₓ (wherein x=0.4 to 2.0), In₂O₃, ITO, SnO, SnO₂, TiO₂, ZrO₂, Li₃PO₄, Li₂O, La₂O₃ and Li₄GeO₄, but the lithium ion conductive material is not restricted thereto. Among these, the most preferred examples include C (carbon) and Li₄Ti₅O₁₂.

Although the coating method is not particularly restricted, a method of forming a dense film on the surface of the positive electrode active compound by a sol-gel method, a gas phase method or the like is preferred.

The average particle size of the positive electrode active compound is preferably 0.1 to 20 μm.

The polyimide precursor in the present invention refers to a resin capable of being converted to a polyimide by heat treatment or chemical treatment, and examples thereof include polyamic acids and polyamic acid esters. The polyamic acid may be obtained by polymerizing a tetracarboxylic dianhydride and a diamine, and the polyamic acid ester may be obtained by polymerizing a dicarboxylic acid diester and a diamine or by reacting an esterification reagent with carboxyl groups of a polyamic acid.

The structure of these polymers is represented by a repeating unit represented by the Formula (1). In the Formula (1), R¹ is a tetravalent organic group having 4 or more carbon atoms, and preferably a tetravalent organic group having 4 to 30 carbon atoms. Examples of the preferable organic group include an organic group having 2 to 4 ring structures which are connected via one or more structures selected from the group consisting of a single bond, a quaternary carbon, —CH₂—, —O—, —SO₂—, —C(CH₃)₂— and —C(CF₃)₂—; and an organic group having one ring structure.

Further, R² is a divalent organic group having 4 or more carbon atoms, and preferably a divalent organic group having 4 to 30 carbon atoms. Examples of the preferable organic group include an organic group having 2 to 4 ring structures which are connected via one or more structures selected from the group consisting of a single bond, a quaternary carbon, —CH₂—, —O—, —SO₂—, —C(CH₃)₂— and —C(CF₃)₂—; and an organic group having one ring structure.

Specific examples of R¹ in Formula (1) include residues of pyromellitic dianhydride, biphenyltetracarboxylic dianhydride, benzophenone tetracarboxylic dianhydride, diphenyl ether tetracarboxylic dianhydride, diphenysulfone tetracarboxylic dianhydride, hexafluoropropylidene bis(phthalic anhydride), cyclobutane tetracarboxylic dianhydride, butane tetracarboxylic dianhydride, cyclopentane tetracarboxylic dianhydride, cyclohexane tetracarboxylic dianhydride and naphthalene tetracarboxylic dianhydride.

The polyimide precursor preferably has a structure(s) represented by Formula (e) (2) and/or (3) below in an amount of 60 to 100 mol %. The use of the polyimide precursor having such a structure(s) has an advantage that a resin composition for positive electrodes of lithium ion cells, which is resistant to deformation and cracking of an electrode after imidization, can be obtained. The amount of the structure(s) is more preferably 70 to 100 mol %, and most preferably 80 to 100 mol %.

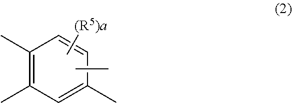

In the Formula, R⁵s are optionally the same or different, and each R⁵ is an organic group having 1 to 10 carbon atoms, nitro group, Cl, Br, I or F; and a is an integer of 0 to 2. From the viewpoint that the resin composition for positive electrodes of lithium ion cells, which is resistant to deformation and cracking of an electrode after imidization, can be obtained, the structures wherein a=0 and no substituent is present are preferable.

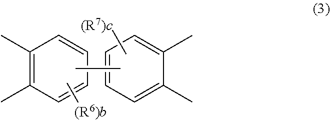

In the Formula, each of R⁶ and R⁷ is an organic group having 1 to 10 carbon atoms, nitro group, Cl, Br, I or F wherein the same groups are optionally employed or different groups are optionally employed in combination as each of R⁶s and R⁷s. Preferred examples of the organic group having 1 to 10 carbon atoms include alkyl groups, alkenyl groups, alkoxyl groups and perfluoroalkyl groups; and b and c are integers of 0 to 3. From the viewpoint that the resin composition for positive electrodes of lithium ion cells, which is resistant to deformation and cracking of an electrode after imidization, can be obtained, the structures wherein b=c=0 and no substituent is present are preferable.

Preferred examples of Formula (2) include a residue of pyromellitic dianhydride; and Preferred examples of Formula (3) include residues of 3,3′,4,4′-biphenyltetracarboxylic dianhydride, 2,3′,3,4′-biphenyltetracarboxylic dianhydride and 2,2′,3,3′-biphenyltetracarboxylic dianhydride.

In cases where the polyimide precursor is a copolymer having a plurality of R¹, the copolymer may be a random copolymer or block copolymer.

In addition to the tetracarboxylic acid and dicarboxylic acid diester, tricarboxylic acids such as trimellitic acid and trimesic acid and derivatives thereof; and dicarboxylic acids such as phthalic acid, naphthalene dicarboxylic acid, adipic acid, hexamethylene dicarboxylic acid and cyclohexane dicarboxylic acid and derivatives thereof may be copolymerized.

Specific examples of R² in Formula (1) include residues of phenylenediamine, diaminodiphenylamide, benzidine, 2,2′-bis(trifluoromethyl)benzidine, 2,2′-dimethylbenzidine, diaminotoluene, diaminoxylene, diaminoethylbenzene, diaminotrifluoromethylbenzene, diaminobis(trifluoromethyl)benzene, diaminopentafluoroethylbenzene, diaminocyanobenzene, diaminodicyanobenzene, diaminobenzoic acid, diaminodicarboxybenzene, diaminodihydroxybenzene, diaminodiphenylmethane, diaminodiphenylether, diaminodiphenylsulfide, diaminodiphenysulfone, diaminobenzanilide, 2,2′-bis(3-amino-4-hydroxyphenyl)hexafluoropropane, 1,4-bis[1-(4-aminophenyl)-1-methylethyl]benzene, bis(aminophenoxy)benzene, bis(aminophenoxyphenyl)sulfone, bis(aminophenoxyphenyl)propane, bis(aminophenoxyphenyl), and the hydrogenated compounds thereof; and ones obtained by substituting at least one hydrogen atoms in the aromatic ring of the above-described diamines by an alkyl group(s) having 1 to 10 carbon atoms, a perfluoroalkyl group(s) having 1 to 10 carbon atoms, an alkoxyl group(s) having 1 to 10 carbon atoms, a phenyl group(s), a hydroxyl group(s), a carboxyl group(s) or an ester group(s).

Specific examples thereof also include residues of aliphatic diamines such as butanediamine, pentanediamine, hexanediamine, heptanediamine, octanediamine, diamino ethylene glycol, diamino propylene glycol, diamino polyethylene glycol, diamino polypropylene glycol, cyclopentyldiamine and cyclohexyldiamine.

The polyimide precursor preferably has a structure(s) represented by Formula (e) (4) and/or (5) below in an amount of 50 to 100 mol %. The use of the polyimide precursor having such a structure(s) has an advantage that the resin composition for positive electrodes of lithium ion cells, which is resistant to deformation and cracking of an electrode after imidization, can be obtained. The amount of the structure(s) is more preferably 60 to 100 mol %, and most preferably 70 to 100 mol %.

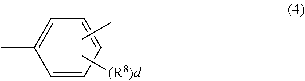

In the Formula, R⁸s are optionally the same or different, and each R⁸ is an organic group having 1 to 10 carbon atoms, nitro group, hydroxyl group, sulfonic group, Cl, Br, I or F. Preferred examples of the organic group having 1 to 10 carbon atoms include alkyl groups, alkenyl groups, alkoxyl groups and perfluoroalkyl groups; and d is an integer of 0 to 4. From the viewpoint that the resin composition for positive electrodes of lithium ion cells, which is resistant to deformation and cracking of an electrode after imidization, can be obtained, the structures wherein d=0 and no substituent is present are preferable.

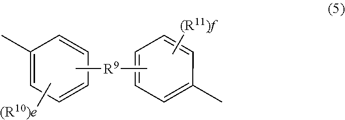

In the Formula, R⁹ is a single bond or —CONH—. In the Formula, each of R¹⁰ and R¹¹ is an organic group having 1 to 10 carbon atoms, nitro group, hydroxyl group, sulfonic group, Cl, Br, I or F wherein the same groups are optionally employed or different groups are optionally employed in combination as each of R¹⁰s and R¹¹ s. Preferred examples of the organic group having 1 to 10 carbon atoms include alkyl groups, alkenyl groups, alkoxyl groups and perfluoroalkyl groups; and e and f are integers of 0 to 4. From the viewpoint that the resin composition for positive electrodes of lithium ion cells, which is resistant to deformation and cracking of an electrode after imidization, can be obtained, the structures wherein e=f=0 and no substituent is present are preferable.

Preferred examples of Formulae (4) and (5) include paraphenylenediamine, metaphenylenediamine, 4,4′-diaminobenzanilide, benzidine, 2,2′-bis(trifluoromethyl)benzidine and 2,2′-dimethylbenzidine.

Further, in order to improve the adhesion with a collector, residues of silicone diamines such as 1,3-bis(3-aminopropyl)tetramethyldisiloxane, 1,3-bis(3-aminopropyl)tetraethyldisiloxane, 1,3-bis(3-aminopropyl)tetramethoxydisiloxane, 1,3-bis(3-aminopropyl)tetrapropyldisiloxane, 1,3-bis(3-aminopropyl)dimethyldiphenyldisiloxane, 1,3-bis(3-aminopropyl)trimethyl hydrodisiloxane, bis(4-aminophenyl)tetramethyldisiloxane, 1,3-bis(4-aminophenyl)tetraphenyldisiloxane, α,ω-bis(3-aminopropyl)hexamethyltrisiloxane, α,ω-bis(3-aminopropyl)permethylpolysiloxane, 1,3-bis(3-aminopropyl)tetraphenyldisiloxane and 1,5-bis(2-aminoethyl)tetraphenyldimethyltrisiloxane may be used for 0.5 to 5 mol % of R².

In cases where the polyimide precursor is a copolymer having a plurality of R², the copolymer may be a random copolymer or block copolymer.

R³ and R⁴ are optionally the same or different, and each of R³ and R⁴ is hydrogen or an organic group having 1 to 10 carbon atoms. Preferred examples of the organic group having 1 to 10 carbon atoms include alkyl groups, alkenyl groups, alkoxyl groups and perfluoroalkyl groups.

In order to make the electrode after imidization more resistant to the deformation, each of R³ and R⁴ is preferably hydrogen or one or more organic groups selected from methyl group and ethyl group.

Next, the method for producing a polyimide precursor of the present invention will now be described.

In case of the polyamic acid, such a method in which a diamine is dissolved in a solvent such as N-methylpyrrolidone (NMP), N,N-dimethylacetamide (DMAC), N,N-dimethylformamide (DMF), γ-butyrolactone (GBL) or dimethylsulfoxide (DMSO), and a tetracarboxylic dianhydride is added thereto to allow reaction, is generally employed. The reaction temperature is usually −20° C. to 100° C., and preferably 0° C. to 50° C. The reaction time is usually 1 minute to 100 hours, and preferably 2 hours to 24 hours. It is preferred to prevent water from entering into the system, for example, by flowing nitrogen during the reaction.

In case of the polyamic acid ester, a tetracarboxylic dianhydride is mixed with an alcohol such as ethanol, propanol or butanol and a base catalyst such as pyridine or triethylamine, and the resultant is reacted at room temperature to 100° C. for several minutes to about 10 hours to obtain a dicarboxylic acid diester compound. Also, the tetracarboxylic dianhydride may be dispersed directly in an alcohol, or the tetracarboxylic dianhydride may be dissolved in a solvent such as NMP, DMAC, DMF, DMSO or GBL, and the resultant is reacted with an alcohol and a base catalyst. The obtained dicarboxylic acid diester is subjected to heat treatment in thionyl chloride or reacted with oxalyl dichloride to obtain a dicarboxylic acid chloride diester. The obtained dicarboxylic acid chloride diester is collected by methods such as distillation and the like, and the collected dicarboxylic acid chloride diester is added dropwise in the presence of pyridine or triethyl amine to a solution in which a diamine is dissolved in a solvent such as NMP, DMAC, DMF, DMSO or GBL. The dropwise addition is preferably carried out at a temperature of −20° C. to 30° C. After completion of the dropwise addition, the resulting mixture is reacted at a temperature of −20° C. to 50° C. for 1 hour to 100 hours to obtain a polyamic acid ester. In cases where the dicarboxylic acid chloride diester is used, hydrochloride is generated as a byproduct, and thus the dicarboxylic acid diester may be reacted with a diamine by using a condensing reagent for peptides such as dicyclohexylcarbodiimide instead of the heat treatment in thionyl chloride or the reaction with oxalyl dichloride. The polyamic acid ester may also be obtained by allowing to react an acetal compound such as dimethylformamide dialkyl acetal with the above-described polyamic acid. The degree of esterification can be adjusted depending on the amount of added acetal compound.

The polyimide in the present invention means a polyimide having the structure that an imidization has been already completed at the point of mixing with the positive electrode active compound.

The structure of these polymers is represented by a repeating unit represented by the Formula (6). In the Formula (6), R¹² is a tetravalent organic group having 4 or more carbon atoms, and preferably a tetravalent organic group having 4 to 30 carbon atoms. Preferable examples of the organic group include an organic group having 2 to 4 ring structures which are connected via one or more structures selected from the group consisting of a single bond, a quaternary carbon, —CH₂—, —O—, —SO₂—, —C(CH₃)₂— and —C(CF₃)₂—; and an organic group having one ring structure. Further, R¹³ is a divalent organic group having 4 or more carbon atoms, and preferably a divalent organic group having 4 to 30 carbon atoms. Preferable examples of the organic group include an organic group having 2 to 4 ring structures which are connected via one or more structures selected from the group consisting of a single bond, a quaternary carbon, —CH₂—, —O—, —SO₂—, —C(CH₃)₂— and —C(CF₃)₂—; and an organic group having one ring structure.

Examples of R¹² in Formula (6) include residues of acid dianhydrides described above as examples of R′. The polyimide precursor preferably has one or more structures selected from the Formulae (7) to (9) in an amount of 50 to 100 mol %. The use of the polyimide having such structures has an advantage that even though the polyimide is soluble, agglutination of imide ring structures during heat treatment does not occur, and a resin composition for positive electrodes of lithium ion cells, which is resistant to deformation and cracking of an electrode, can be obtained. The amount of the structures is more preferably 60 to 100 mol %, and most preferably 70 to 100 mol %.

In the Formula (7), R¹⁴s are optionally the same or different, and each R¹⁴ is an organic group having 1 to 10 carbon atoms, nitro group, Cl, Br, I or F. Preferred examples of the organic group having 1 to 10 carbon atoms include alkyl groups, alkenyl groups, alkoxyl groups and perfluoroalkyl groups; and g is an integer of 0 to 2. From the viewpoint that the resin composition for positive electrodes of lithium ion cells, which is resistant to deformation and cracking of an electrode, can be obtained, the structures wherein g=0 and no substituent is present are preferable.

In the Formula (8), R¹⁵ is an organic group selected from the group consisting of a single bond, —O—, —S—, —CO—, —C(CF₃)₂— and —CONH—. In the Formula, each of R¹⁶ and R¹⁷ is an organic group having 1 to 10 carbon atoms, nitro group, hydroxyl group, sulfonic group, Cl, Br, I or F wherein the same groups are optionally employed or different groups are optionally employed in combination as each of R¹⁶s and R¹⁷s. Preferred examples of the organic group having 1 to 10 carbon atoms include alkyl groups, alkenyl groups, alkoxyl groups and perfluoroalkyl groups; and h and i are integers of 0 to 3. From the viewpoint that the resin composition for positive electrodes of lithium ion cells, which is resistant to deformation and cracking of an electrode, can be obtained, the structures wherein h=i=0 and no substituent is present are preferable.

In the Formula (9), each of R¹⁸ to R²¹ is an organic group having 1 to 10 carbon atoms, nitro group, Cl, Br, I or F wherein the same groups are optionally employed or different groups are optionally employed in combination as each of R¹⁸s to R²¹s. Preferred examples of the organic group having 1 to 10 carbon atoms include alkyl groups, alkenyl groups, alkoxyl groups and perfluoroalkyl groups; j and m are integers of 0 to 3, and k and l are integers of 0 to 4. From the viewpoint that the resin composition for positive electrodes of lithium ion cells, which is resistant to deformation and cracking of an electrode, can be obtained, the structures wherein j=k=l=m=0 and no substituent is present are preferable.

Examples of R¹³ in Formula (6) include residues of diamines described above as examples of R².

The method for producing a polyimide according to the present invention will now be described.

In general, a polyimide precursor is first prepared by the same method as described above, and the obtained precursor is then imidized. Examples of imidization methods include heat treatments and chemical treatments. In case of the heat treatments, a polyimide precursor or a solution thereof is heated at a temperature of 150° C. to 300° C., preferably 180° C. to 250° C. to allow ring closure by dehydration. In case of the chemical treatments, acetic anhydride and pyridine are added to a polyimide precursor or a solution thereof, and the resultant is stirred at a temperature of 0 to 60° C. for 1 to 24 hours to allow ring closure by dehydration.

In the present invention, the weight-average molecular weight of the polyimide precursor and/or polyimide is preferably in the range of 5000 to 2000000. In cases where the weight-average molecular weight thereof is less than 5000, the mechanical strength of the polyimide is drastically decreased, and the electrode may be broken. In cases where the weight-average molecular weight thereof is higher than 2000000, the coating performance to a collector is drastically decreased. The weight-average molecular weight thereof is more preferably 10000 to 200000, and most preferably 20000 to 100000.

The weight-average molecular weight of the polyimide precursor and/or polyimide in the present invention was measured by the GPC method in terms of polystyrene using a developing solvent in which phosphoric acid and lithium chloride were added to N-methylpyrrolidone (NMP) to a concentration of 0.05 mol/l respectively.

The polyimide precursor and/or polyimide in the present invention is(are) mixed with the positive electrode active compound and in some cases with a conductive aid and/or solvent to obtain a resin composition for positive electrodes of lithium ion cells, the obtained composition is then applied on a collector, and the collector is subjected to heat treatment to prepare an electrode. In case where the polyimide precursor is used, the polyimide precursor is imidized during the heat treatment.

The content of the polyimide precursor and/or polyimide in the resin composition of the present invention is preferably 1 to 40 parts by weight, and more preferably 3 to 15 parts by weight with respect to 100 parts by weight of the positive electrode active compound. When the content thereof is within the range of 1 to 40 parts by weight, the adhesiveness is promoted, and the decrease in cell properties caused by increase in electrical resistance, decrease in electrolyte infusion rate, and the like is unlikely to occur.

In order to decrease the electrical resistance, conductive aids such as Ketjen Black, carbon nanotube and acetylene black may be contained in the resin composition of the present invention. The content of the conductive aids is preferably not less than 0.1 parts by weight and not more than 20 parts by weight with respect to 100 parts by weight of the positive electrode active compound.

Further, the resin composition of the present invention may contain the other resins in addition to the polyimide precursor and/or polyimide as required. Examples of the other resins include PVdF and PTFE, as well as styrene-butadiene rubber, cellulose, acrylic resin, nitrile-butadiene rubber and polyacrylonitrile. The preferable content thereof is 0.1 to 10 parts by weight with respect to 100 parts by weight of the total amount of the polyimide precursor and/or polyimide. Such other resins contained therein can contribute to making the positive electrode after being heat-treated more flexible.

Further, the resin composition of the present invention may contain surfactants, viscosity modifiers and the like as required. Examples of the viscosity modifiers include carboxymethylcellulose, hydroxyethylcellulose and hydroxypropylcellulose. Silane coupling agents such as aminopropyltrimethoxysilane, trimethoxyvinylsilane and trimethoxyglycidoxysilane; titan coupling agents, triazine compounds, phenanthroline compounds, triazole compounds and the like may be contained in an amount of 0.1 to 10 parts by weight with respect to 100 parts by weight of the total amount of the polyimide precursor and/or polyimide. Such agents and compounds contained therein can contribute to further promote adhesion of the positive electrode.

In the resin composition for positive electrodes of lithium ion cells of the present invention, the method of mixing the polyimide precursor and/or polyimide, positive electrode active compound, and additives such as a conductive aid, surfactant and solvent as required is that the polyimide precursor and/or polyimide is(are) adjusted to have adequate viscosity by using NMP or the like as a solvent; an active compound and a conductive aid are added thereto; and the resultant is kneaded well to obtain the resin composition. The kneading is preferably carried out by employing a planetary centrifugal mixer; media dispersion with a bead mill, ball mill or the like; or a triple roll, thereby preparing a homogeneous dispersion. Moreover, since the positive electrode active compound is very unstable to water, and in particular, it is necessary to pay attention to contamination of water. Therefore, in addition to NMP, solvents with low water-absorption are preferred, and most preferred examples of the solvents include GBL, propyleneglycol dimethyl ether, ethyl lactate, cyclohexanone and tetrahydrofuran. In order to improve coating performance of a binder solution, solvents such as propyleneglycol monomethyl ether acetate, various alcohols, methyl ethyl ketone and methyl iso-butyl ketone may be contained preferably in an amount of 1 to 30% by weight based on all solvents.

Next, the production method of a positive electrode which is prepared from the resin composition of the present invention will now be described by way of an example.

The resin composition for positive electrodes of lithium ion cells of the present invention is applied to a thickness of 1 to 500 μm on a metal foil. Examples of the metal foil include aluminum foil, nickel foil, titanium foil, copper foil and stainless steel foil; and aluminum foil is commonly used.

As to the coating of the metal foil with the resin composition for positive electrodes of lithium ion cells of the present invention, the metal foil is coated by means such as a spin coating, roll coating, slit die coating, spray coating, dip coating and screen printing. Since the coating is usually carried out on both sides of the metal foil, the usual method is that one side thereof is first coated; the solvent is removed at a temperature of 50 to 400° C. for 1 minute to 20 hours in air; under an atmosphere of an inert gas such as nitrogen or argon; or in vacuum; and the opposite side thereof is then coated and dried. However, both sides thereof may be coated at the same time by means such as a roll coating and slit die coating.

In cases where the polyimide precursor is used, the applied composition is heat-treated at a temperature of 100 to 500° C. for 1 minute to 24 hours to convert the polyimide precursor into a polyimide, thereby obtaining a reliable positive electrode. Preferably, the composition is heat-treated at a temperature of 200 to 450° C. for 30 minutes to 20 hours. In order to prevent contamination of water, the heat treatment is preferably carried out in an inert gas such as nitrogen gas or in vacuum.

Next, a lithium ion cell prepared by using the resin composition for positive electrodes of lithium ion cells of the present invention will now be described. A separator is interposed between a positive electrode and a negative electrode, and an electrolyte solution in which a lithium salt such as LiPF₆, LiBF₄, LiClO₄, LiN(CF₃SO₂)₂ or LiC₄BO₈ was dissolved is injected thereto, thereby obtaining a lithium ion cell. The solvent used for the electrolyte solution plays a role as a medium in which ions involved in the electrochemical reaction of the cell can move. Examples of the solvent include carbonate, ester, ether, ketone, alcohol and aprotic solvents. Examples of the carbonate solvent include dimethyl carbonate (DMC), diethyl carbonate (DEC), dipropyl carbonate (DPC), methyl propyl carbonate (MPC), ethyl propyl carbonate (EPC), methyl ethyl carbonate (MEC), ethyl methyl carbonate (EMC), ethylene carbonate (EC), propylene carbonate (PC) and butylene carbonate (BC). Examples of the ester solvent include methyl acetate, ethyl acetate, n-propyl acetate, methyl propionate, ethyl propionate, γ-butyrolactone, decanolide, valerolactone, mevalonolactone and caprolactone. Examples of the ether solvent include dibutyl ether, tetraglyme, diglyme, dimethoxyethane, 2-methyltetrahydrofuran and tetrahydrofuran. Examples of the ketone solvent include cyclohexanone. Examples of the alcohol solvent include ethyl alcohol and isopropyl alcohol. Examples of the aprotic solvent include nitriles; amides such as dimethylformamide; dioxolanes such as 1,3-dioxolane; and sulfolanes. Two or more of these solvents may be used, and the ratio of contents thereof may be selected properly depending on the intended performance of the cell. For example, in case of the carbonate solvent, a cyclic carbonate and a chain carbonate are preferably used in combination at a volume ratio of 1:1 to 1:9, thereby improving the performance of the electrolyte solution.

### EXAMPLES

Examples will now be described below in order to explain the present invention in more detail, but the present invention is not restricted to these Examples. Each property in Examples was evaluated by the following method.

### (1) Thermal Linear Expansion Coefficient

Each varnish obtained in Synthesis Examples 1 to 20 was coated on a 4-inch silicon wafer, and the coated wafer was preliminarily dried on a hot plate at 100° C. for 3 minutes. The wafer with the coating was then heated at 350° C. for 1 hour in an oven (INH-9: produced by Koyo Thermo Systems Co., Ltd.) in which the oxygen concentration had been controlled to be not more than 50 ppm. In this case, the coating condition was set such that the thickness of the coating after being heated was 10 μm±1 μm.

Next, the heated wafer was immersed in 45% aqueous solution of hydrofluoric acid at room temperature for 10 minutes, and after washing the wafer with water, the polyimide coating was peeled from the wafer. The peeled coating was dried at 120° C. for 1 hour, and then used for the measurement of the thermal linear expansion coefficient. The measuring apparatus and measurement conditions are described below:

Apparatus: EXSTAR TMA/SS5100 (produced by Seiko Instruments Inc.)
Conditions: (i) heating from room temperature to 250° C. at a heating rate of 3.5° C./min. (First Temperature Rising);
(ii) cooling to room temperature temporarily;
(iii) heating again from room temperature to 400° C. at a heating rate of 3.5° C./min.

### (Second Temperature Rising)

The average of the thermal linear expansion coefficient in the range of room temperature to 200° C. measured during the Second Temperature Rising was calculated, which was used as the value of the thermal linear expansion coefficient.

### (2) Cycle Characteristics

The prepared coin cell was set in a discharge and charge test device (produced by KEISOKUKI CENTER CO., LTD., BLS5500), and the measurements were carried out at Cutoff voltages (V (vs Li+/Li)) and test temperatures (° C.) described in Table 1. As described in Table 1, the measurements were carried out by changing the conditions depending on the composite oxides containing lithium. The electric current during 1st to 10th cycles was set to be 0.2 C, the electric current during 11th to 100th cycles was set to be 1 C, and the percentage of the discharged capacity at 100th cycle with respect to the discharged capacity at 1st cycle was calculated to evaluate cycle characteristics.

TABLE 1

| Composite | | |
|---|---|---|
| oxide containing | Cutoff voltage | Test temperature |
| lithium in coin cell | (V (vs Li+/Li)) | (° C.) |
| LiFePO₄ | 2.0-4.0 | 27 |
| LiCoO₂ | 3.0-4.2 | 27 |
| LiMn₂O₄ | 3.0-4.2 | 60 |
| LiMi_{0.33}Mn_{0.33}Co_{0.33}O₂ | 2.5-4.2 | 60 |
| LiNi_{0.8}Co_{0.15}Al_{0.05}O₂ | 3.0-4.2 | 60 |

### (3) Output Characteristics

The prepared coin cell was set in a discharge and charge test device (produced by KEISOKUKI CENTER CO., LTD., BLS5500), and the measurements were carried out by changing Cutoff voltages (V (vs Li+/Li)) depending on the composite oxides containing lithium as described in Table 2. The measurements were carried out at a test temperature of 27° C. and at two electric current points of 0.1 C and 30 C. The percentage of the capacity at the output of 30 C with respect to the capacity at the output of 0.1 C was calculated to evaluate output characteristics.

TABLE 2

| Composite | | |
|---|---|---|
| oxide containing | Cutoff voltage | Test temperature |
| lithium in coin cell | (V (vs Li+/Li)) | (° C.) |
| LiFePO₄ | 2.0-4.0 | 27 |
| LiCoO₂ | 3.0-4.2 | 27 |
| LiMn₂O₄ | 3.0-4.2 | 27 |
| LiMi_{0.33}Mn_{0.33}Co_{0.33}O₂ | 2.5-4.2 | 27 |
| LiNi_{0.8}Co_{0.15}Al_{0.05}O₂ | 3.0-4.2 | 27 |

The abbreviations used in Synthesis Examples means the following compounds:

NMP: N-methyl-2-pyrrolidone (Produced by Mitsubishi Chemical Corporation)
GBL: γ-butyrolactone (Produced by Mitsubishi Chemical Corporation)
PMDA: pyromellitic dianhydride (Produced by Daicel Corporation)
BTDA: 3,3′,4,4′-benzophenonetetracarboxylic dianhydride (Produced by Daicel Corporation)
BPDA: 3,3′,4,4′-biphenyltetracarboxylic dianhydride (Produced by Mitsubishi Chemical Corporation)
ODPA: 3,3′,4,4′-diphenylethertetracarboxylic dianhydride (Produced by JSR TRADING CO., LTD)
BSAA: 4,4′-(4,4′-isopropylidenephenoxy)bisphthalic anhydride (Produced by Shanghai Research Institute of Synthetic Resins)
DAE: 4,4′-diaminodiphenylether (Produced by Wakayama Seika Kogyo Co., LTD.)
PDA: paraphenylenediamine (Produced by TOKYO CHEMICAL INDUSTRY CO., LTD.)
TFMB: 4,4′-bis(amino)-2,2′-bis(trifluoromethyl)biphenyl (Produced by Wakayama Seika Kogyo Co., LTD.)
DABA: 4,4′-diaminobenzanilide (Produced by Wakayama Seika Kogyo Co., LTD.)
SiDA: 1,3-bis(3-aminopropyl)tetramethyldisiloxane (Produced by Shin-Etsu Chemical Co., Ltd.)
PA: phthalic anhydride (Produced by Wako Pure Chemical Industries, Ltd.)
6FAP: 2,2-bis(3-amino-4-hydroxyphenyl)hexafluoropropane (Produced by AZ Electronic Materials)
MAP: 3-aminophenol (Produced by Wako Pure Chemical Industries, Ltd.)
APB: 1,3-bis(3-aminophenoxy)benzene (Produced by TOKYO CHEMICAL INDUSTRY CO., LTD.)
RIKACID BT-100:1,2,3,4-butanetetracarboxylic dianhydride (Produced by New Japan Chemical co., ltd.)
RIKACID TDA-100:1,3,3a,4,5,9b-hexahydro-5-(tetrahydro-2,5-dioxo-3-furanyl)naphtho[1,2-c]furan-1,3-dione (Produced by New Japan Chemical co., ltd.)
JEFFAMINE D-400: polyoxypropylenediamine having an average molecular weight of 430 (Produced by Huntsman Corporation)

### Synthesis Example 1

To a four-necked flask, 26.02 g (0.05 mol) of BSAA, 9.9 g (0.05 mol) of RIKACID BT-100 and 100 g of NMP were added under nitrogen atmosphere, and the resulting mixture was stirred at 40° C. for 30 minutes. To the mixture, 2.18 g (0.02 mol) of MAP and 13.18 g of NMP were added, followed by stirring the mixture at 60° C. for 1 hour. One hour later, 32.96 g (0.09 mol) of 6FAP and 100 g of NMP were added thereto, the resulting solution was further stirred at 60° C. for 1 hour, and then at 200° C. for 6 hours. Six hours later, the solution was allowed to cool to room temperature, and NMP was added thereto to finally obtain a polyimide solution having a solid concentration of 20%, which was named varnish A.

### Synthesis Example 2

To a four-necked flask, 18.61 g (0.06 mol) of ODPA, 12 g (0.04 mol) of RIKACID TDA-100 and 137.25 g of NMP were added under nitrogen atmosphere, and the resulting mixture was stirred at 40° C. for 30 minutes. To the mixture, 2.18 g (0.02 mol) of MAP and 10 g of NMP were added, followed by stirring the mixture at 60° C. for 1 hour. One hour later, 32.96 g (0.09 mol) of 6FAP and 50 g of NMP were added thereto, the resulting solution was further stirred at 60° C. for 1 hour, and then at 200° C. for 6 hours. Six hours later, the solution was allowed to cool to room temperature and added to 3 L of pure water to precipitate a polymer, followed by removing the precipitates by filtration. The procedure of adding the removed precipitates to 3 L of pure water and removing the precipitates by filtration was repeated another 5 times, and the obtained precipitates were dried under nitrogen atmosphere in an oven at 80° C. for 5 days.

To 20 g of the dried powders, 80 g of NMP was added to dissolve the powders, and the obtained solution was then subjected to filtration through a membrane filter having a pore diameter of 10 μm to finally obtain a polyimide solution having a solid concentration of 20%, which was named varnish B.

### Synthesis Example 3

The same procedure as in Synthesis Example 2 was carried out except that 31.02 g (0.1 mol) of ODPA and 138.48 g of NMP were added in place of 18.61 g (0.06 mol) of ODPA, 12 g (0.04 mol) of RIKACID TDA-100 and 137.25 g of NMP, to finally obtain a polyimide solution having a solid concentration of 20%, which was named varnish C.

### Synthesis Example 4

To a four-necked flask, 31.02 g (0.1 mol) of ODPA and 137.1 g of NMP were added under nitrogen atmosphere, and the resulting mixture was stirred at 40° C. for 30 minutes. To the mixture, 2.18 g (0.02 mol) of MAP and 10 g of NMP were added, followed by stirring the mixture at 60° C. for 1 hour. One hour later, 13.15 g (0.045 mol) of APB, 19.35 g (0.045 mol) of JEFFAMINE D-400 and 50 g of NMP were added thereto, and the resulting solution was further stirred at 60° C. for 1 hour, and then at 200° C. for 6 hours. Six hours later, the solution was allowed to cool to room temperature and added to 3 L of pure water to precipitate a polymer, followed by removing the precipitates by filtration. The procedure of adding the removed precipitates to 3 L of pure water and removing the precipitates by filtration is repeated another 5 times, and the obtained precipitates were dried under nitrogen atmosphere in an oven at 80° C. for 5 days.

To 20 g of the dried powders, 80 g of NMP was added to dissolve the powders, and the obtained solution was then subjected to filtration through a membrane filter having a pore diameter of 10 μm to finally obtain a polyimide solution having a solid concentration of 20%, which was named varnish D.

### Synthesis Example 5

The same procedure as in Synthesis Example 2 was carried out except that 52.05 g (0.1 mol) of BSAA and 201.57 g of NMP were added in place of 18.61 g (0.06 mol) of ODPA, 12 g (0.04 mol) of RIKACID TDA-100 and 137.25 g of NMP, to finally obtain a polyimide solution having a solid concentration of 20%, which was named varnish E.

### Synthesis Example 6

To a four-necked flask, 14.62 g (0.05 mol) of APB, 21.5 g (0.05 mol) of JEFFAMINE D-400 and 120 g of NMP were added under nitrogen atmosphere to dissolve these diamines at room temperature. Then, 30.25 g (0.0975 mol) of ODPA and 79.11 g of NMP were added thereto, and the resulting solution was stirred at 60° C. for 6 hours. Six hours later, the solution was allowed to cool to room temperature, and NMP was added thereto to finally obtain a polyimide precursor solution having a solid concentration of 20%, which was named varnish F.

### Synthesis Example 7

To a four-necked flask, 19.02 g (0.095 mol) of DAE, 1.24 g (0.005 mol) of SiDA and 120 g of NMP were added under nitrogen atmosphere to dissolve these diamines at room temperature. Then, 31.58 g (0.098 mol) of BTDA and 35.5 g of NMP were added thereto, and the resulting solution was stirred at 60° C. for 6 hours. Six hours later, the solution was allowed to cool to room temperature, and NMP was added thereto to finally obtain a polyimide precursor solution having a solid concentration of 20%, which was named varnish G.

### Synthesis Example 8

The same procedure as in Synthesis Example 6 was carried out except that 14.89 g (0.048 mol) of ODPA, 10.91 g (0.05 mol) of PMDA and 65.76 g of NMP were added in place of 30.25 g (0.0975 mol) of ODPA and 79.11 g of NMP, to finally obtain a polyimide precursor solution having a solid concentration of 20%, which was named varnish H.

### Synthesis Example 9

The same procedure as in Synthesis Example 7 was carried out except that 15.47 g (0.048 mol) of BTDA, 10.47 g (0.048 mol) of PMDA, 1.18 g (0.008 mol) of PA and 22.14 g of NMP were added in place of 31.58 g (0.098 mol) of BTDA and 35.5 g of NMP, to finally obtain a polyimide precursor solution having a solid concentration of 20%, which was named varnish I.

### Synthesis Example 10

The same procedure as in Synthesis Example 7 was carried out except that 9.02 g (0.028 mol) of BTDA, 15.27 g (0.07 mol) of PMDA and 13.65 g of NMP were added in place of 31.58 g (0.098 mol) of BTDA and 35.5 g of NMP, to finally obtain a polyimide precursor solution having a solid concentration of 20%, which was named varnish J.

### Synthesis Example 11

The same procedure as in Synthesis Example 7 was carried out except that 14.27 g (0.0485 mol) of BPDA, 10.58 g (0.0485 mol) of PMDA and 15.33 g of NMP were added in place of 31.58 g (0.098 mol) of BTDA and 35.5 g of NMP, to finally obtain a polyimide precursor solution having a solid concentration of 20%, which was named varnish K.

### Synthesis Example 12

The same procedure as in Synthesis Example 6 was carried out except that 16 g (0.05 mol) of TFMB, 10.01 g (0.05 mol) of DAE and 89.67 g of NMP were added in place of 14.62 g (0.05 mol) of APB, 21.5 g (0.05 mol) of JEFFAMINE D-400 and 120 g of NMP, to finally obtain a polyimide precursor solution having a solid concentration of 20%, which was named varnish L.

### Synthesis Example 13

To a four-necked flask, 10.01 g (0.05 mol) of DAE, 5.4 g (0.05 mol) of PDA and 120 g of NMP were added under nitrogen atmosphere to dissolve these diamines at room temperature. Then, 28.69 g (0.975 mol) of BPDA and 12.3 g of NMP were added thereto, followed by stirring the resulting solution at 60° C. for 6 hours. Six hours later, the solution was allowed to cool to room temperature, and NMP was added thereto to finally obtain a polyimide precursor solution having a solid concentration of 20%, which was named varnish M.

### Synthesis Example 14

The same procedure as in Synthesis Example 13 was carried out except that 14.09 g (0.062 mol) of DABA, 6.81 g (0.034 mol) of DAE, 0.99 g (0.004 mol) of SiDA and 139.44 g of NMP were added in place of 10.01 g (0.05 mol) of DAE, 5.4 g (0.05 mol) of PDA and 120 g of NMP, to finally obtain a polyimide precursor solution having a solid concentration of 20%, which was named varnish N.

### Synthesis Example 15

The same procedure as in Synthesis Example 13 was carried out except that 4.81 g (0.024 mol) of DAE, 7.78 g (0.072 mol) of PDA, 0.99 g (0.004 mol) of SiDA and 114.51 g of NMP were added in place of 10.01 g (0.05 mol) of DAE, 5.4 g (0.05 mol) of PDA and 120 g of NMP, to finally obtain a polyimide precursor solution having a solid concentration of 20%, which was named varnish 0.

### Synthesis Example 16

To a four-necked flask, 4.81 g (0.024 mol) of DAE, 16.36 g (0.072 mol) of DABA, 0.99 g (0.004 mol) of SiDA and 140.25 g of NMP were added under nitrogen atmosphere to dissolve these diamines at room temperature. Then, 28.69 g (0.0975 mol) of BPDA and 12.3 g of NMP were added, followed by stirring the resultant at 40° C. for 2 hours. Two hours later, a solution obtained by dissolving 33.01 g of dimethylformamide diethyl acetal in 17.84 g of NMP was added thereto, and the resulting solution was further stirred at 40° C. for 2 hours. Two hours later, the solution was allowed to cool to room temperature and added to 3 L of pure water to precipitate a polymer, followed by removing the precipitates by filtration. The procedure of adding the removed precipitates to 3 L of pure water and removing the precipitates by filtration was repeated another 5 times, and the obtained precipitates were then dried under nitrogen atmosphere in an oven at 50° C. for 5 days.

To 20 g of the dried powders, 80 g of NMP was added to dissolve the powders, and the obtained solution was then subjected to filtration through a membrane filter having a pore diameter of 1 μm to finally obtain a polyimide precursor solution having a solid concentration of 20%, which was named varnish P.

### Synthesis Example 17

To a four-necked flask, 29.42 g (0.1 mol) of BPDA, 9.2 g (0.2 mol) of ethanol, 120 g of GBL and 15.82 g (0.2 mol) of pyridine were added dropwise slowly at room temperature under nitrogen atmosphere. After the dropwise addition, the resulting mixture was stirred at room temperature for 6 hours, and then at 40° C. for 16 hours, and 16 hours later, the mixture was allowed to cool to room temperature. Then, 41.27 g (0.2 mol) of dicyclohexylcarbodiimide was added thereto, the resultant was stirred at room temperature for 1 hour, and a solution obtained by dispersing 5.01 g (0.025 mol) of DAE and 8.1 g (0.075 mol) of PDA in 50 g of GBL was added dropwise slowly thereto, followed by further stirring the resulting solution at room temperature for 4 hours. Four hours later, a filtrate obtained by filtering the obtained dispersion was added to 3 L of a mixed solvent of pure water/ethanol (weight ratio 3/1) to precipitate a polymer, and the precipitates were removed by filtration. The procedure of adding the removed precipitates to 3 L of a mixed solvent of pure water/ethanol and removing the precipitates by filtration was repeated another 5 times, and the obtained precipitates were dried under nitrogen atmosphere in an oven at 50° C. for 5 days.

To 20 g of the dried powders, 80 g of NMP was added to dissolve the powders, and the obtained solution was subjected to filtration through a membrane filter having a pore diameter of 1 μm to finally obtain a polyimide precursor solution having a solid concentration of 20%, which was named varnish Q.

### Synthesis Example 18

To a four-necked flask, 26.03 g (0.1 mol) of 4,4′-diamino-p-terphenyl and 120 g of NMP were added under nitrogen atmosphere to dissolve diamines at room temperature. Then, 35.52 g (0.96 mol) of 3,3′,4,4′-p-terphenyl dianhydride and 64.65 g of NMP were added thereto, and the resulting solution was stirred at 40° C. for 6 hours. Six hours later, the solution was allowed to cool to room temperature, and NMP was added thereto to finally obtain a polyimide precursor solution having a solid concentration of 20%, which was named varnish R.

### Synthesis Example 19

To a four-necked flask, 26.03 g (0.1 mol) of 4,4′-diamino-p-terphenyl and 120 g of NMP were added under nitrogen atmosphere to dissolve diamines at room temperature. Then, 35.52 g (0.96 mol) of 3,3′,4,4′-p-terphenyl dianhydride and 64.65 g of NMP were added thereto, and the resulting solution was stirred at 60° C. for 1 hour, and then 200° C. for 6 hours. Six hours later, the solution was allowed to cool to room temperature, and NMP was added thereto to finally obtain a polyimide precursor solution having a solid concentration of 20%, which was named varnish S.

### Synthesis Example 20

The same procedure as in Synthesis Example 1 was carried out except that 19.8 g (0.1 mol) of RIKACID BT-100 and 51.64 g of NMP were added in place of 26.02 g (0.05 mol) of BSAA, 9.9 g (0.05 mol) of RIKACID BT-100 and 100 g of NMP, to finally obtain a polyimide solution having a solid concentration of 20%, which was named varnish T.

The positive electrode active compounds used in Examples and Comparative Examples are as follows:

LiFePO₄ coated with carbon (produced by Hohsen Corp.)
LiCoO₂ whose surface was coated with Li₄Ti₅O₁₂
LiMn₂O₄ whose surface was coated with Li₄Ti₅O₁₂
LiNi_{0.33}Mn_{0.33}Co_{0.33}O₂ whose surface was coated with Li₄Ti₅O₁₂
LiNi_{0.8}CO_{0.15}Al_{0.05}O₂ whose surface was coated with Li₄Ti₅O₁₂
LiCoO₂ whose surface was coated with LiZrO₃
LiCoO₂ whose surface was coated with Li₄SiO₄

### Uncoated LiCoO₂

### Uncoated LiMn₂O₄

### Uncoated LiNi_{0.33}Mn_{0.33}Co_{0.33}O₂

### Uncoated LiNi_{0.8}CO_{0.15}Al_{0.05}O₂

The coating of Li₄Ti₅O₁₂, LiZrO₃ and Li₄SiO₄ on the surface of each composite oxide containing lithium was carried out as described in Coating Examples 1 to 6.

### Coating Example 1

A solution obtained by dissolving 9.31 g of lithium ethoxide (produced by KOUJUNDO CHEMICAL LABORATORY CO., LTD., 99.9%) and 63.3 g of titanium tetraisopropoxide (Wako Pure Chemical Industries, Ltd., not less than 95%) in 187 mL of absolute ethanol was used as a sol-gel spray liquid, and the surface of LiCoO₂ (produced by Nippon Chemical Industrial, average particle size: 5 μm) was coated with the sol-gel spray liquid using a spray coating apparatus. Thereafter, a heat treatment was carried out under an inert Ar gas atmosphere at 400° C. for 1 hour to obtain LiCoO₂ whose surface was coated with Li₄Ti₅O₁₂. The amount of the sol-gel spray liquid in spraying, that is the time of spraying the liquid, was controlled such that the thickness of the coating after the heat treatment was 5 nm.

### Coating Example 2

The same procedure as in Coating Example 1 was carried out except that LiMn₂O₄ was used in place of LiCoO₂ to obtain LiMn₂O₄ whose surface was coated with Li₄Ti₅O₁₂.

### Coating Example 3

The same procedure as in Coating Example 1 was carried out except that LiNi_{0.33}Mn_{0.33}Co_{0.33}O₂ was used in place of LiCoO₂ to obtain LiNi_{0.33}Mn_{0.33}Co_{0.33}O₂ whose surface was coated with Li₄Ti₅O₁₂.

### Coating Example 4

The same procedure as in Coating Example 1 was carried out except that LiNi_{0.8}CO_{0.15}Al_{0.05}O₂ was used in place of LiCoO₂ to obtain LiNi_{0.8}CO_{0.15}Al_{0.05}O₂ whose surface was coated with Li₄Ti₅O₁₂.

### Coating Example 5

The same procedure as in Coating Example 1 was carried out except that tetraisopropoxyzirconium (produced by KOUJUNDO CHEMICAL LABORATORY CO., LTD., 99.99%) was used in place of titanium tetraisopropoxide (Wako Pure Chemical Industries, Ltd., not less than 95%) to obtain LiCoO₂ whose surface was coated with LiZrO₃.

### Coating Example 6

The same procedure as in Coating Example 1 was carried out except that tetraethoxysilane (produced by KOUJUNDO CHEMICAL LABORATORY CO., LTD., 99.9999%) was used in place of titanium tetraisopropoxide (Wako Pure Chemical Industries, Ltd., not less than 95%) to obtain LiCoO₂ whose surface was coated with Li₄SiO₄.

### Example 1

The varnish A synthesized in the Synthesis Example 1 was taken in an amount of 2.5 g, and 0.7 g of Ketjen Black was added thereto, followed by mixing the resulting mixture for 8 minutes with a mixing deaerator (produced by THINKY CORPORATION, ARE-310). Thereafter, NMP was added slowly thereto in increments of 0.2 g until a paste having a fluidity such that when the vessel is just tilted, the paste hardly moves, but when the tilted vessel is hit against a desk, the paste moves, was formed, to obtain a homogeneous paste.

A positive electrode active compound (LiFePO₄ coated with carbon) in an amount of 8.8 g was added thereto, and the resulting mixture was mixed for 4 minutes using a mixing deaerator. Until the same fluidity of a paste as described above can be attained, 0.2 g each of NMP was added slowly thereto to prepare a resin composition for positive electrodes of lithium ion cells.

An aluminum foil having a thickness of 20 μm was coated with the resin composition for positive electrodes of lithium ion cells by using a doctor blade (produced by TESTER SANGYO CO., LTD., PI-1210), and the coated foil was preliminary dried in an oven (produced by Tokyo Rikakikai, WFO-400) at 80° C. for 30 minutes. Thereafter, the foil was sized to a diameter of 11 cm by punching to obtain electrodes. The thicknesses and weights of the obtained electrodes were measured to calculate the densities and capacities thereof. For evaluating cell properties, when the calculation was carried out by setting the electrode area to 0.95 cm² and the positive electrode active compound to 160 mAh/g, an electrode having a density of 1.5 to 3.2 g/cm³ and a capacity per unit area of 1.0 to 2.0 mAh/cm² was selected and used. The selected electrode was placed in a sample bottle made of glass and subjected to main drying under vacuum at 200° C. for 5 hours.

Here, one sheet of Celgard #2400 (produced by Polypore K.K., CELGARD) as the separator and one sheet of GA100 (produced by ADVANTEC) as the glass filter for preventing a minute short circuit, both of which were sized to a diameter of 16 cm by punching and dried at 70° C. over night, were used, respectively.

Parts for a coin cell (produced by Hohsen Corp., CR2032 type) were provided in a dry room, the electrode obtained above was placed on the center of the saucer part, and one drop of an electrolyte solution (1M solution of LiPF₆ in ethylene carbonate/diethyl carbonate=1/1 weight ratio, produced by KISHIDA CHEMICAL Co., Ltd.) was added thereto. The separator obtained above was placed thereon, and one drop of the electrolyte solution was further added thereto, followed by placing the above-obtained glass filter.

Then, the electrolyte solution was added thereto until the glass filter was completely immersed in the electrolyte solution, and a lithium metal for a negative electrode (thickness: 0.5 mm, produced by Honjo Metal Co., Ltd.) and a SUS plate, which were sized to a diameter of 13 cm by punching, were placed thereon in this order. Finally, a spring was placed thereon, a lid part was then put thereon, and after pushing the lid part in, the parts were closed with a caulking tool to obtain a coin cell.

The cycle characteristics and output characteristics were evaluated for the obtained coin cell by the above-described method.

### Examples 2 to 17

The same procedure as in Example 1 was carried out except that each varnish described in Table 3 was used in place of varnish A to prepare a coin cell, and the cycle characteristics and output characteristics thereof were evaluated by the above-described method.

### Examples 18 to 20

The same procedure as in Example 1 was carried out except that each varnish described in Table 3 was used in place of varnish A, and LiCoO₂ coated with Li₄Ti₅O₁₂ was used as a positive electrode active compound to prepare a coin cell, and the cycle characteristics and output characteristics thereof were evaluated by the above-described method.

### Examples 21 to 25

The same procedure as in Example 1 was carried out except that each varnish described in Table 3 was used in place of varnish A, and LiCoO₂ coated with each Li conductive material described in Table 3 was used as a positive electrode active compound to prepare a coin cell, and the cycle characteristics and output characteristics thereof were evaluated by the above-described method.

### Examples 26 to 28

The same procedure as in Example 1 was carried out except that varnish P was used in place of varnish A, and each composite oxide containing lithium, which was coated with Li₄Ti₅O₁₂, was used as a positive electrode active compound to prepare a coin cell, and the cycle characteristics and output characteristics thereof were evaluated by the above-described method.

### Comparative Examples 1 to 3

The same procedure as in Example 1 was carried out except that each varnish described in Table 4 was used in place of varnish A, and LiCoO₂ which was not coated with a Li conductive material was used as a positive electrode active compound to prepare a coin cell, and the cycle characteristics and output characteristics thereof were evaluated by the above-described method.

### Comparative Examples 4 to 6

The same procedure as in Example 1 was carried out except that each varnish described in Table 4 was used in place of varnish A to prepare a coin cell, and the cycle characteristics and output characteristics thereof were evaluated by the above-described method.

### Comparative Example 7

The same procedure as in Example 1 was carried out except that 2.5 g of 20% solution of polyvinylidene fluoride (PVdF) in NMP was used in place of varnish A to prepare a coin cell, and the cycle characteristics and output characteristics thereof were evaluated by the above-described method.

### Comparative Example 8

The same procedure as in Example 1 was carried out except that 3.5 g of 20% solution of polyvinylidene fluoride (PVdF) in NMP and 0.7 g of Ketjen Black were added in place of 2.5 g of varnish A and 0.7 g of Ketjen Black; and the positive electrode active compound (LiFePO₄ coated with carbon) was added in an amount of 8.6 g of in place of 8.8 g to prepare a coin cell, and the cycle characteristics and output characteristics thereof were evaluated by the above-described method.

### Comparative Example 9

The same procedure as in Example 1 was carried out except that 2.5 g of 20% aqueous solution of styrene-butadiene rubber (SBR) was used in place of varnish A to prepare a coin cell, and the cycle characteristics and output characteristics thereof were evaluated by the above-described method.

### Comparative Examples 10 to 12

The same procedure as in Example 1 was carried out except that 2.5 g of 20% solution of polyvinylidene fluoride (PVdF) in NMP was used in place of varnish A and each positive electrode active compound described in Table 4 was used, to prepare a coin cell, and the cycle characteristics and output characteristics thereof were evaluated by the above-described method.

The evaluation results of the above-described Examples and Comparative Examples are shown in Tables 3 and 4.

TABLE 3

| | | | Thermal linear | | | | Output |
|---|---|---|---|---|---|---|---|
| | | | expansion coefficient | Composite oxide | Lithium ion | Cycle characteristics | characteristics |
| | | Varnish | (ppm/° C.) | containing lithium | conductive material | (%) | (%) |
| Example | 1 | A | 45 | LiFePO₄ | Carbon | 75 | 63 |
| | 2 | B | 40 | LiFePO₄ | Carbon | 77 | 63 |
| | 3 | C | 40 | LiFePO₄ | Carbon | 80 | 64 |
| | 4 | D | 67 | LiFePO₄ | Carbon | 72 | 62 |
| | 5 | E | 48 | LiFePO₄ | Carbon | 77 | 64 |
| | 6 | F | 56 | LiFePO₄ | Carbon | 80 | 65 |
| | 7 | G | 40 | LiFePO₄ | Carbon | 85 | 65 |
| | 8 | H | 60 | LiFePO₄ | Carbon | 83 | 65 |
| | 9 | I | 40 | LiFePO₄ | Carbon | 88 | 69 |
| | 10 | J | 40 | LiFePO₄ | Carbon | 88 | 69 |
| | 11 | K | 28 | LiFePO₄ | Carbon | 87 | 71 |
| | 12 | L | 42 | LiFePO₄ | Carbon | 85 | 66 |
| | 13 | M | 28 | LiFePO₄ | Carbon | 87 | 74 |
| | 14 | N | 22 | LiFePO₄ | Carbon | 87 | 78 |
| | 15 | O | 17 | LiFePO₄ | Carbon | 88 | 81 |
| | 16 | P | 17 | LiFePO₄ | Carbon | 88 | 81 |
| | 17 | Q | 17 | LiFePO₄ | Carbon | 88 | 81 |
| | 18 | O | 17 | LiCoO₂ | Li₄Ti₅O₁₂ | 72 | 64 |
| | 19 | P | 17 | LiCoO₂ | Li₄Ti₅O₁₂ | 72 | 64 |
| | 20 | Q | 17 | LiCoO₂ | Li₄Ti₅O₁₂ | 72 | 64 |
| | 21 | E | 48 | LiCoO₂ | LiZrO₃ | 72 | 62 |
| | 22 | E | 48 | LiCoO₂ | Li₄SiO₄ | 72 | 63 |
| | 23 | G | 40 | LiCoO₂ | Li₄SiO₄ | 72 | 63 |
| | 24 | Q | 17 | LiCoO₂ | LiZrO₃ | 72 | 62 |
| | 25 | Q | 17 | LiCoO₂ | Li₄SiO₄ | 72 | 64 |
| | 26 | P | 17 | LiMn₂O₄ | Li₄Ti₅O₁₂ | 72 | 64 |
| | 27 | P | 17 | LiNi_{0.33}Mn_{0.33}Co_{0.33}O₂ | Li₄Ti₅O₁₂ | 72 | 61 |
| | 28 | P | 17 | LiNi_{0.8}Co_{0.15}Al_{0.05}O₂ | Li₄Ti₅O₁₂ | 74 | 64 |

TABLE 4

| | | | Thermal linear | | | Cycle | Output |
|---|---|---|---|---|---|---|---|
| | | | expansion coefficient | Composite oxide | Lithium ion | characteristics | characteristics |
| | | Varnish | (ppm/° C.) | containing lithium | conductive material | (%) | (%) |
| Comparative | 1 | O | 17 | LiCoO₂ | None | 43 | 0 |
| Example | 2 | P | 17 | LiCoO₂ | None | 43 | 0 |
| | 3 | Q | 17 | LiCoO₂ | None | 43 | 0 |
| | 4 | R | 2 | LiFePO₄ | Carbon | 23 | 24 |
| | 5 | S | 2 | LiFePO₄ | Carbon | 35 | 45 |
| | 6 | T | 55 | LiFePO₄ | Carbon | 30 | 40 |
| | 7 | PVdF | — | LiFePO₄ | Carbon | 40 | 43 |
| | 8 | PVdF | — | LiFePO₄ | Carbon | 70 | 60 |
| | 9 | SBR | — | LiFePO₄ | Carbon | 56 | 45 |
| | 10 | PVdF | — | LiMn₂O₄ | None | 54 | 42 |
| | 11 | PVdF | — | LiNi_{0.33}Mn_{0.33}Co_{0.33}O₂ | None | 58 | 40 |
| | 12 | PVdF | — | LiNi_{0.8}Co_{0.15}Al_{0.05}O₂ | None | 59 | 38 |

1. A resin composition for positive electrodes of lithium ion cells, the composition comprising a polyimide precursor whose average thermal linear expansion coefficient in the range of 20° C. to 200° C. after being imidized is 3 to 50 ppm, and/or a polyimide whose average thermal linear expansion coefficient in the range of 20° C. to 200° C. is 3 to 50 ppm, and a positive electrode active compound, wherein said positive electrode active compound is one obtained by coating the surface of a composite oxide containing lithium with a lithium ion conductive material.

2. A resin composition for positive electrodes of lithium ion cells, the composition comprising a polyimide precursor having a repeating structure represented by Formula (1) below and a positive electrode active compound, wherein said positive electrode active compound is one obtained by coating the surface of a composite oxide containing lithium with a lithium ion conductive material: 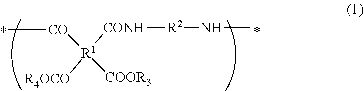
(wherein R¹ is a tetravalent organic group having 4 or more carbon atoms; R² is a divalent organic group having 4 or more carbon atoms; R³ and R⁴ are optionally the same or different, and each of R³ and R⁴ is hydrogen or an organic group having 1 to 10 carbon atoms).

3. The resin composition for positive electrodes of lithium ion cells, according to claim 2, wherein 60 to 100 mol % of R¹ in the structure of the polyimide precursor having a repeating structure represented by the Formula (1) are represented by Formula (e) (2) and/or (3) below: 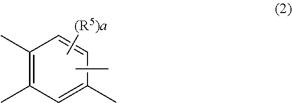
(wherein R⁵s are optionally the same or different, and each R⁵ is an organic group having 1 to 10 carbon atoms, nitro group, Cl, Br, I or F; and a is an integer of 0 to 2); 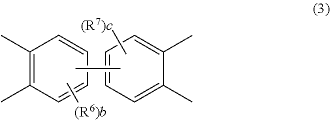
(wherein each of R⁶ and R⁷ is an organic group having 1 to 10 carbon atoms, nitro group, Cl, Br, I or F wherein the same groups are optionally employed or different groups are optionally employed in combination as each of R⁶s and R⁷s; and b and c are integers of 0 to 3).

4. The resin composition for positive electrodes of lithium ion cells, according to claim 2, wherein 50 to 100 mol % of R² in the structure of the polyimide precursor having a repeating structure represented by the Formula (1) are represented by Formula (e) (4) and/or (5) below: 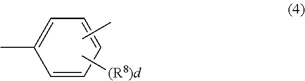
(wherein R⁸s are optionally the same or different, and each R⁸ is an organic group having 1 to 10 carbon atoms, nitro group, hydroxyl group, sulfonic group, Cl, Br, I or F; and d is an integer of 0 to 4); 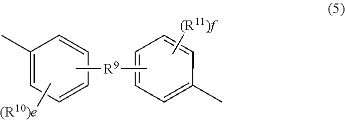
(wherein R⁹ is a single bond or —CONH—; each of R¹⁰ and R¹¹ is an organic group having 1 to 10 carbon atoms, nitro group, hydroxyl group, sulfonic group, Cl, Br, I or F wherein the same groups are optionally employed or different groups are optionally employed in combination as each of R¹⁰s and R¹¹s; and e and f are integers of 0 to 4).

5. A resin composition for positive electrodes of lithium ion cells, the composition comprising a polyimide having a repeating structure represented by Formula (6) below and a positive electrode active compound, wherein said positive electrode active compound is one obtained by coating the surface of a composite oxide containing lithium with a lithium ion conductive material; and 50 to 100% of R¹² in the structure of the polyimide having a repeating structure represented by the Formula (6) are represented by one or more structures selected from Formulae (7) to (9) below: 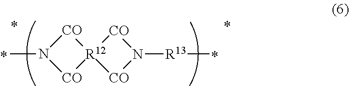
(wherein R¹² is a tetravalent organic group having 4 or more carbon atoms; and R¹³ is a divalent organic group having 4 or more carbon atoms); 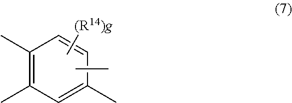
(wherein R¹⁴s are optionally the same or different, and each R¹⁴ is an organic group having 1 to 10 carbon atoms, nitro group, Cl, Br, I or F; and g is an integer of 0 to 2); 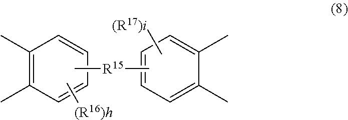
(wherein R¹⁵ is an organic group selected from the group consisting of a single bond, —O—, —S—, —CO—, —C(CF₃)₂— and —CONH—; each of R¹⁶ and R¹⁷ is an organic group having 1 to 10 carbon atoms, nitro group, hydroxyl group, sulfonic group, Cl, Br, I or F wherein the same groups are optionally employed or different groups are optionally employed in combination as each of R¹⁶s and R¹⁷s; and h and i are integers of 0 to 3); 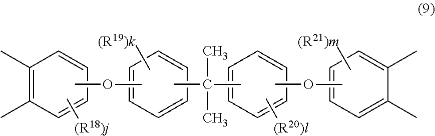
(wherein each of R¹⁸ to R²¹ is an organic group having 1 to 10 carbon atoms, nitro group, Cl, Br, I or F wherein the same groups are optionally employed or different groups are optionally employed in combination as each of R¹⁸s to R²¹s; j and m are integers of 0 to 3; and k and l are integers of 0 to 4).

6. The resin composition for positive electrodes of lithium ion cells, according to claim 1, wherein said lithium ion conductive material has an oxidation-reduction potential of not more than 2.5 V vs Li+/Li.

7. The resin composition for positive electrodes of lithium ion cells, according to claim 1, wherein said lithium ion conductive material is Li₄Ti₅O₁₀ and/or carbon.

8. A positive electrode for lithium ion cells, the electrode comprising a metal foil and the composition according to claim 1 which was applied on one side or both sides of said metal foil.

9. The resin composition for positive electrodes of lithium ion cells, according to claim 2, wherein said lithium ion conductive material has an oxidation-reduction potential of not more than 2.5 V vs Li+/Li.

10. The resin composition for positive electrodes of lithium ion cells, according to claim 3, wherein said lithium ion conductive material has an oxidation-reduction potential of not more than 2.5 V vs Li+/Li.

11. The resin composition for positive electrodes of lithium ion cells, according to claim 4, wherein said lithium ion conductive material has an oxidation-reduction potential of not more than 2.5 V vs Li+/Li.

12. The resin composition for positive electrodes of lithium ion cells, according to claim 5, wherein said lithium ion conductive material has an oxidation-reduction potential of not more than 2.5 V vs Li+/Li.

13. The resin composition for positive electrodes of lithium ion cells, according to claim 2, wherein said lithium ion conductive material is Li₄Ti₅O₁₀ and/or carbon.

14. The resin composition for positive electrodes of lithium ion cells, according to claim 3, wherein said lithium ion conductive material is Li₄Ti₅O₁₀ and/or carbon.

15. The resin composition for positive electrodes of lithium ion cells, according to claim 4, wherein said lithium ion conductive material is Li₄Ti₅O₁₀ and/or carbon.

16. The resin composition for positive electrodes of lithium ion cells, according to claim 5, wherein said lithium ion conductive material is Li₄Ti₅O₁₀ and/or carbon.

17. The resin composition for positive electrodes of lithium ion cells, according to claim 6, wherein said lithium ion conductive material is Li₄Ti₅O₁₀ and/or carbon.

18. A positive electrode for lithium ion cells, the electrode comprising a metal foil and the composition according to claim 2 which was applied on one side or both sides of said metal foil.

19. A positive electrode for lithium ion cells, the electrode comprising a metal foil and the composition according to claim 5 which was applied on one side or both sides of said metal foil.
